(19) United States
(12) Patent Application Publication
(10) Pub. No.: US 2007/0230377 A1
(43) Pub. Date: Oct. 4, 2007

(54) Communication apparatus for enabling coexistence of communication systems

(76) Inventors: Shigekiyo Nosaka, Osaka (JP); Go Kuroda, Osaka (JP); Koji Ikeda, Fukuoka (JP); Akio Kurobe, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/730,488

(22) Filed: Apr. 2, 2007

(30) Foreign Application Priority Data
Apr. 3, 2006 (JP) 2006-102273

(51) Int. Cl. H04L 5/14; H04J 3/06

(52) U.S. Cl. 370/294; 370/503

(57) ABSTRACT

Provided is a communication apparatus which prevents, when two or more communication systems share a single communication medium in a time-division manner, an occurrence of situation where only a particular communication system suffers an influence of noise synchronizing with an AC power supply cycle or a half cycle thereof. When the communication systems share a single communication medium 121 in a time-division manner, a communication control section 209 determines a coexistence communication period, which is cyclically allocated to the communication systems, to be N×M+A (N: arbitrary integer, M: half cycle of an AC power supply cycle, A: arbitrary offset value which is not an integral multiple of the half cycle of the AC power supply cycle). A synchronization signal transmission/reception section 212 transmits and receives a synchronization signal to and from a communication apparatus belonging to another communication system so as to synchronize with the communication apparatus.

### BACKGROUND OF THE INVENTION

1. Field of the Invention

The present invention relates to a communication apparatus which enables a plurality of communication systems to coexist, and particularly relates to a communication apparatus which enables a plurality of communication systems, which use a same communication medium, to share communication resources by TDM (Time Division Multiplexing).

2. Description of the Background Art

There is a PLC (Power Line Communication) technology, which is one of the communication methods for allowing a PC (Personal Computer) at home to access the Internet and in which the PC at home is connected to a network device such as a broadband router. Since an existing power line is used as a communication medium in this power line communication technology, new wiring work is unnecessary, and a high-speed communication is realized by only inserting a power plug into any power socket at home. For this reason, research and development, and demonstration experiments of the power line communication technology have been actively carried out all over the world. In Europe and the United States, this technology has already been commercialized in a number of forms.

For example, there is the HomePlug 1.0 specification standardized by the HomePlug Powerline Alliance in the United States (see Yu-Ju Lin, “A Comparative Performance Study of Wireless and Power Line Networks”, IEEE Communication Magazine, April, 2003, p54-p63 (hereinafter, referred to as Non-Patent Document 1)). The HomePlug 1.0 specification is designed to be mainly applied to the Internet, mailing and file transfer performed by personal computers. The HomePlug 1.0 specification adopts a CSMA/CA technique for media access control for controlling which power line communication modem is to have an access to a power line, and realizes best-effort communication which does not guarantee a band to be used.

FIG. 12 shows a configuration of a general communication system for accessing the Internet. In FIG. 12, a personal computer 2501 is connected to an Ethernet® 2511 and broadband router 2502, and further connected to the Internet 2522 via an access line 2512. In general, ADSL, FTTH or the like is used for the access line 2512. When a place where the access line 2512 is drawn into a home network 2521 is different from a room where the personal computer 2501 is used, cable extension of the Ethernet® 2511 becomes a problem. For this reason, a power line communication apparatus has been commercialized in the form of a conversion adaptor between a power line communication medium and the Ethernet®.

FIG. 13 shows a configuration of a communication system in which conversion adaptors are used. In FIG. 13, two power line communication-Ethernet® conversion adaptors 2601 and 2602 are respectively connected to power sockets in the home network 2521 in which the personal computer 2501 and broadband router 2502 are placed. Here, best-effort communication is realized by performing power line communication via an in-home power line 2614. As shown herein, by using the power line communication technology, the necessity of new wiring work is eliminated, and high-speed communication is realized only by inserting a power plug into any power socket at home.

FIG. 14 is a block diagram showing an internal configuration of a general power line communication modem which is provided as a bridge for an Ethernet® 2811. In FIG. 14, the power line communication modem comprises an AFE (Analog Front End) 2801, digital modulation section 2808, communication control section 2809 and an Ethernet® I/F section 2810. The AFE 2801 includes a BPF (Band-Pass Filter) 2802, AGC (Automatic Gain Control) 2803, A/D conversion section 2804, LPF (Low-Pass Filter) 2805, PA (Power Amplifier) 2806 and a D/A conversion section 2807. Hereinafter, operations of the power line communication modem will be described.

When, in the case where an Ethernet® frame is transmitted into a power line, the Ethernet®frame arrives via the Ethernet® 2811, the communication control section 2809 is notified of the arrival via the Ethernet® I/F section 2810. The communication control section 2809 determines a state of a communication path to output frame data to the digital modulation section 2808 at an appropriate timing. The digital modulation section 2808 performs error correction addition, encoding, framing, and the like to modulate the frame data into a transmission data string. The D/A conversion section 2807 converts the transmission data string from a digital signal to an analog signal. The PA 2806 amplifies the analog signal. The LPF 2805 cuts off, from the amplified analog signal, signals other than communication band components, and inputs only the communication band components into a power line.

Next, in the case where signals are received from the power line, the BPF 2802 extracts a signal of a communication band. The AGC 2803 amplifies the extracted signal. The A/D conversion section 2804 converts the amplified signal, which is an analog signal, into digital data. The digital modulation section 2808 performs, for the digital data, frame synchronization detection, equalization, decoding, error correction and the like to demodulate the digital data and notifies the communication control section 2809 of resultant data as reception data. Thereafter, the reception data is transmitted as an Ethernet® frame from the Ethernet® I/F section 2810 to the Ethernet® 2811.

Currently, there are a plurality of power line communication schemes, e.g., the aforementioned HomePlug version 1.0. Therefore, there may be a case where such a plurality of communication schemes coexist when a power line communication apparatus is used at home.

FIG. 15 shows a configuration of a communication system which is a result of adding two power line communication apparatuses 2701 and 2702 to the communication system of FIG. 13. Here, the power line communication-Ethernet® conversion adaptors 2601 and 2602 are both based on a communication scheme M1, and capable of communicating with each other. The power line communication apparatuses 2701 and 2702 are both based on a communication scheme M2, and capable of communicating with each other. However, an apparatus based on the communication scheme M1 and an apparatus based on the communication scheme M2 each do not understand a signal transmitted from the other apparatus.

Described below with reference to FIGS. 16A to 16C is a situation which occurs when these apparatuses perform communication on the in-home power line 2614. FIG. 16A shows a state of data transmission performed between the power line communication-Ethernet® conversion adaptors 2601 and 2602. FIG. 16B shows a state of data transmission performed between the power line communication apparatuses 2701 and 2702. In FIG. 16C, the data transmissions shown in FIGS. 16A and 16B are shown, in a superimposing manner, on a temporal axis and frequency axis. In FIGS. 16A to 16C, the horizontal axis shows time, and the longitudinal axis shows a frequency.

As shown in FIG. 16A, the power line communication-Ethernet® conversion adaptors 2601 and 2602 perform communication of data 2901, 2902 and 2903 by using frequencies from fa to fb. Also, as shown in FIG. 16B, the power line communication apparatuses 2701 and 2702 perform communication of data 2911, 2912 and 2913 by using frequencies from fc to fd. FIG. 16C shows that the data 2901 and data 2911 are transmitted during a same time period with a same frequency band. Similarly, the data 2903 and data 2913 are transmitted during a same time period with a same frequency band.

In general, when a plurality of communication apparatuses perform communication using a same communication medium, a technique such as CSMA (Carrier Sense Multiple Access) is used to avoid a simultaneous transmission of a plurality of pieces of data. However, since the transmission apparatus based on the communication scheme M1 and the transmission apparatus based on the communication scheme M2 each do not understand a signal transmitted from the other transmission apparatus, the simultaneous transmission of a plurality of pieces of data is unavoidable.

In the home network 2521, all the power lines are connected via a distribution switchboard. When power line communication systems based on different schemes (in the example of FIG. 15, a power line communication system including the power line communication-Ethernet® conversion adaptors 2601 and 2602, and a power line communication system including the power line communication apparatuses 2701 and 2702) are used in the home network 2521, a power line communication system based on one scheme recognizes a signal, which a power line communication system based on another scheme transmits, as a noise. For this reason, when a plurality of power line communication systems perform data communications at the same time, the data communications interfere with each other as shown in FIG. 16C, and as a result, a communication speed is greatly reduced.

Conventionally, there have been suggested methods with which to prevent, when a plurality of power line communication systems based on different communication schemes share a single power line communication medium to perform communications, the communications from interfering with each other. In these methods, a common signal, which all the plurality of power line communication systems based on different schemes understand (hereinafter, referred to as a coexistence signal), is defined and used such that the power line communication medium is shared in a time-division manner (see, e.g., “HomePlug AV White Paper” (hereinafter, referred to as Non-Patent Document 2)).

Non-Patent Document 2 discloses a method in which a plurality of power line communication systems based on different communication systems use a signal, which synchronizes with an AC power supply cycle, so as to use a power line communication medium in a time-division manner. FIG. 17 briefly illustrates a conventional method disclosed by Non-Patent Document 2 for sharing the power line communication medium in a time-division manner. In FIG. 17, a time point t1, at which a phase of a sinusoidal waveform of an AC power supply voltage 3011 is 0 degree, and a time point t2, at which a time period whose length corresponds to a length of two power supply cycles has passed from the time point t1, are defined. Further, a time point ta, at which [symbol] has passed from the time point t1, and a time point tb, at which [symbol] has passed from the time point t2, are defined. In the case where power line communication systems use the method disclosed by Non-Patent Document 2, the time point t1, at which the phase of the AC power supply voltage 3011 is 0 degree, is detected, and the time point ta, at which [symbol] has passed from the time point t1, is used as an origin of synchronization, and a power line communication medium is shared from the time point ta, in a time-division manner, for each two power supply voltage cycles. Hereinafter, a period for enabling each power line communication system to periodically use a common power line communication medium is referred to as a coexistence communication period, and a cycle of the period is referred to as a coexistence communication period cycle. In the example of Non-Patent Document 2, the coexistence communication period has a length corresponding to a length of two AC power supply voltage cycles. This period starts from the time point ta, and then repeats thereafter. Also, the coexistence communication period cycle has a length corresponding to the length of two AC power supply voltage cycles.

To be specific, in Non-Patent Document 2, power line communication systems transmit to and receive from each other, in a beacon region 3001 starting from the time point ta, a control signal called beacon, thereby determining an access right for accessing the power line communication medium in a data communication region 3002 subsequent to the beacon region 3001. This allows power line communication apparatuses, which are capable of transmitting to and receiving from each other the control signal called beacon defined in Patent Document 2, to share the power line communication medium.

In the above-described conventional method disclosed by Non-Patent Document 2 for sharing the power line communication medium in a time-division manner, the coexistence communication period is set to be twice as long as the AC power supply cycle. Here, it is generally known that a noise or impedance fluctuation, which synchronizes with the AC power supply cycle or a half cycle thereof, occurs in the power line communication medium. For this reason, when the coexistence communication period which is an integral multiple of the AC power supply cycle is used as described above, a problem may arise in which a transmission path condition is extremely deteriorated during a time period during which a particular power line communication system uses the power line communication medium.

FIG. 18 illustrates the problem of the conventional method disclosed by Non-Patent Document 2 for sharing the power line communication medium in a time-division manner. In an example of FIG. 18, the coexistence communication period is a time period which starts from a time point when a phase of a waveform of an AC power supply voltage 3111 is 0 degree and which has a length of two power supply cycles. The phase of the waveform of the AC power supply voltage 3111 becomes 0 degree at a time point t(i) at which a coexistence communication period 1 starts. The coexistence communication period 1 ends at a time point t(i+1) at which a time period having the length of two cycles of the AC power supply voltage 3111 has passed from the time point t(i). Then, a next coexistence communication period 2 starts. The coexistence communication period 2 ends at a time point t(i+2) at which the time period having the length of two cycles of the AC power supply voltage 3111 has passed from the time point t(i+1). Although not shown in FIG. 18, it may be considered that a next coexistence communication period further starts from a time point t(i+2), and thereafter, the coexistence communication period, which has the length of two cycles of the AC power supply voltage 3111, repeats.

Further, in the example of FIG. 18, a noise 3112 synchronizing with the AC power supply voltage 3111 is present on the power line communication medium. FIG. 18 shows that the greater the waveform amplitude of the noise 3112, the stronger is the noise 3112. To be specific, a relatively strong noise is present during a time period starting from a point at which the phase of the AC power supply voltage 3111 is 0 degree, the time period having a length of approximately 40% of a length of the power supply cycle.

Described below is a case where when the coexistence communication period is specified as described above and the power line communication medium is in such a state as to contain the noise 3112, communication systems 1, 2 and 3 equally share the coexistence communication period in a time-division manner. To be specific, the communication system 1 exclusively uses the power line communication medium from a starting point of the coexistence communication period 1, i.e., the time point t(i), to a time point at which ⅓ of the entire coexistence communication period 1 has passed. Subsequently, the communication system 2 exclusively uses the power line communication medium from a time point, which is immediately after the communication system 1 has finished the exclusive use of the power line communication medium, to a time point at which ⅔ of the entire coexistence communication period 1 has passed. Further, the communication system 3 exclusively uses the power line communication medium from a time point, which is immediately after the communication system 2 has finished the exclusive use of the power line communication medium, to an end point t(i+1) of the coexistence communication period 1.

Similarly, in the coexistence communication period 2, the communication system 1 exclusively uses the power line communication medium from a starting point t(i+1) of the coexistence communication period 2 to a time point at which ⅓ of the entire coexistence communication period 2 has passed. Subsequently, the communication system 2 exclusively uses the power line communication medium from a time point, which is immediately after the communication system 1 has finished the exclusive use of the power line communication medium, to a time point at which ⅔ of the entire coexistence communication period 2 has passed. Further, the communication system 3 exclusively uses the power line communication medium from a time point, which is immediately after the communication system 2 has finished the exclusive use of the power line communication medium, to an end point t(i+2) of the coexistence communication period 2. Although not shown in FIG. 18, it may be considered that in the coexistence communication period, which is present after the time point t(i+2), each of the communication systems 1 to 3 exclusively uses the power line communication medium in accordance with a same schedule as that of the coexistence communication periods 1 and 2.

Here, the focus is on the noise 3112 in the coexistence communication period 1. In the coexistence communication period 1, a region in which a strong noise is present appears twice (to be specific, regions 3101 and 3102 appear). The region 3101 is a first half of a time period during which the communication system 1 exclusively uses the power line communication medium, and the region 3102 is a second half of a time period during which the communication system 2 exclusively uses the power line communication medium. This indicates that each of the communication systems 1 and 2 is required to perform, for an approximately half of the time period which said each of the communication systems 1 and 2 exclusively uses the power line communication medium, communication using a communication path in an extremely deteriorated condition, whereas the communication system 3 is always allowed to perform communication using a communication path in a favorable condition. Similarly, the focus here is on the noise 3112 in the coexistence communication period 2. Also in the coexistence communication period 2, a region in which a strong noise is present appears twice (to be specific, regions 3103 and 3104 appear). The region 3103 is a first half of a time period during which the communication system 1 exclusively uses the power line communication medium, and the region 3104 is a second half of a time period during which the communication system 2 exclusively uses the power line communication medium. This indicates that also in the coexistence communication period 2, each of the communication systems 1 and 2 is required to perform, for an approximately half of the time period which said each of the communication systems 1 and 2 exclusively uses the power line communication medium, communication using a communication path in an extremely deteriorated condition, whereas the communication system 3 is always allowed to perform communication using a communication path in a favorable condition. It can be easily inferred that a communication status in the coexistence communication period, which is present after the time point t(i+2), is the same as described above.

As described above, in FIG. 18, unlike the communication systems 1 and 2, the communication system 3 is always allowed to perform communication using the communication path in a favorable condition. Thus, although the divided time periods, which are respectively allocated to the communication systems for the exclusive use of the power line communication medium, have an equal length, the difference in condition of the communication path causes an amount of data, which is actually communicated, to greatly vary even when communication apparatuses having the same capabilities are used. This is because both the coexistence communication period and noise 3112 synchronize with the AC power supply voltage 3111. This problem is unavoidable as long as the coexistence communication period is an integral multiple of the cycle of the AC power supply voltage 3111. Further, FIG. 18 shows that the noise 3112 has a same cycle as that of the AC power supply voltage 3111. In reality, however, there is often a case where the noise has a same cycle as a half cycle of the AC power supply voltage 3111.

A conceivable method for solving the above problem is to shorten the coexistence communication period cycle. For instance, in the example of FIG. 18, the length of the period during which the noise 3112 is strong is approximately 40% of the length of the cycle of the AC power supply voltage 3111. For this reason, if the coexistence communication period cycle is sufficiently shorter than 40% of the cycle of the AC power supply voltage 3111, a strong noise equally exists, for each communication system, in the time period for exclusive use of the power line communication medium. However, when the AC power supply voltage 3111 is 50 Hz, the cycle thereof is 20 msec; when the AC power supply voltage 3111 is 60 Hz, the cycle thereof is approximately 16.7 msec; and 40% of the cycle of the AC power supply voltage 3111 of 60 Hz is approximately 6.7 msec. When this length of time is divided to be allocated to a plurality of communication systems, a period, during which one of the systems is allowed to exclusively use the power line communication medium, becomes extremely short, thereby causing a great deterioration in communication efficiency.

FIG. 19 shows a general frame configuration in digital data communication. Generally speaking, digital data communication is performed in units of frames by using such a frame as shown in FIG. 19. The frame can be divided into: a header 3201 for which a modulation method relatively resistant to noise is used; a payload 3202 which is a region for transferring user data and the like; and an error detection/correction code 3203. The error detection/correction code 3203 is used for detecting, during a transmission, whether a transmission error exists in the payload 3202, or for correcting such an existing transmission error. Here, the header 3201 is a fixed-length header. In general, a fixed modulation method with a low transmission speed is used for the header 3201, and the payload 3202 is a variable-length payload. A modulation method used for the payload 3202 and a size of the payload 3202 are generally written in the header 3201. The number of error detections/corrections which the error detection/correction code 3203 can perform is limited. If the number of error bits existing in the payload 3202 does not exceed the number of error detections/corrections which the error detection/correction code 3203 can perform, the error bits can be detected/corrected.

In the digital data communication as described above, the header 3201 is a fixed-length header, and the payload 3202 is a variable-length payload. The greater the proportion of the payload 3202 to the frame, the higher is the transmission efficiency. In other words, the larger the proportion of the payload 3202 to the frame, the greater is the amount of user data transmittable within a predetermined period of time. However, the larger the size of the payload 3202, the greater is the number of transmission errors existing therein. This increases a possibility that the number of existing transmission errors exceeds the number of error detections/corrections which the error detection/correction code 3203 can perform. Therefore, it is crucial, in digital data communication, to keep a balance between these two aspects, thereby realizing optimal data transmission efficiency.

If the coexistence communication period cycle is set to be sufficiently shorter than the cycle of the AC power supply voltage 3111, the proportion of each of the header 3201 and the error detection/correction code 3203 in the frame configuration shown in FIG. 19 becomes very high. This consequently causes deterioration in transmission efficiency. For this reason, it is unrealistic to use, as a method to solve the above problem, the method for setting a value of the coexistence communication period cycle to be sufficiently smaller than the cycle of the AC power supply voltage 3111.

### SUMMARY OF THE INVENTION

The present invention is to provide a communication apparatus which is capable of: solving the above conventional problem; preventing transmission efficiency from greatly deteriorating when two or more communication systems share a single communication medium in a time-division manner; and preventing an occurrence of a situation where only a particular communication system suffers an influence of a noise which synchronizes with the AC power supply cycle or a half cycle thereof.

The present invention is directed to a communication apparatus belonging to one of two or more communication systems which are capable of sharing a single communication medium in a time-division manner. In order to achieve the aforementioned object, the communication apparatus of the present invention comprises: a communication control section for, when the two or more communication systems share the single communication medium in a time-division manner, determining a coexistence communication period, which is cyclically allocated to the communication systems, to be N×M+A (N: an arbitrary integer, M: a half cycle of an AC power supply cycle, A: an arbitrary offset value which is not an integral multiple of the half cycle of the AC power supply cycle); and a synchronization signal transmission/reception section for transmitting and receiving a synchronization signal to and from a communication apparatus, which belongs to another one of the two or more communication systems, so as to synchronize with the communication apparatus.

Preferably, the offset value A is L/M (L is an arbitrary real number satisfying 0<L<M).

The synchronization signal transmission/reception section may transmit and receive the synchronization signal by setting, as a synchronization signal transmission/reception region, a predetermined time period from a starting point of the coexistence communication period determined by the communication control section.

The communication apparatus may further comprise a zero-crossing detection section for detecting a zero-crossing point of an AC power supply. In this case, the communication control section generates a synchronization signal based on the zero-crossing point detected by the zero-crossing detection section.

Preferably, the zero-crossing detection section automatically detects the AC power supply cycle. In such a case, the communication control section determines the coexistence communication period based on the AC power supply cycle detected by the zero-crossing detection section.

Processes performed by components of the above-described communication apparatus may be considered as a communication method which provides a series of process steps. This communication method is provided in the form of a program for causing a computer to perform the series of process steps. When this program is supplied to the computer, this program may be stored in a computer readable storage medium. Further, function blocks constituting the above-described communication apparatus may be partly realized by an LSI, which is an integrated circuit.

The present invention is capable of shifting a timing of a noise, which occurs synchronizing with the AC power supply cycle or a half cycle thereof, with respect to the coexistence communication period cycle, thereby causing, when two or more communication systems share a single communication medium in a time division manner, the noise to equally affect each communication system while preventing a transmission efficiency from greatly deteriorating.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows schematic configurations of communication systems, in each of which communication apparatuses according to a first embodiment of the present invention are used;

FIG. 2 is a block diagram showing an exemplary configuration of a communication apparatus according to the first embodiment of the present invention;

FIG. 3 shows single-phase voltage waveforms of AC power supply according to the first embodiment of the present invention;

FIG. 4 shows three-phase voltage waveforms of AC power supply according to the first embodiment of the present invention;

FIG. 5 shows an exemplary configuration of a coexistence communication period according to the first embodiment of the present invention;

FIG. 6 shows a configuration example of a synchronization signal according to the first embodiment of the present invention;

FIG. 7 shows an exemplary situation where the communication systems according to the first embodiment of the present invention coexist;

FIG. 8 shows a schematic configuration of a communication system in which communication apparatuses according to a second embodiment of the present invention are used;

FIG. 9 shows an exemplary configuration of schedule information according to the second embodiment of the present invention;

FIG. 10 shows exemplary values set in the schedule information of the second embodiment of the present invention;

FIG. 11 shows an exemplary network system in which the present invention is applied to power line transmission;

FIG. 12 shows a configuration of a general communication system for accessing the Internet;

FIG. 13 shows a configuration of a communication system in which conversion adaptors are used;

FIG. 14 is a block diagram showing an internal configuration of a general power line communication modem;

FIG. 15 shows a configuration of a communication system which is a result of adding two power line communication apparatuses 2701 and 2702 to the communication system of FIG. 13;

FIG. 16A shows a state of data transmission performed between power line communication-Ethernet® conversion adaptors 2601 and 2602;

FIG. 16B shows a state of data transmission performed between power line communication apparatuses 2701 and 2702;

FIG. 16C shows, in a superimposing manner, the data transmissions of FIGS. 16A and 16B on a temporal axis and frequency axis;

FIG. 17 briefly shows a conventional method for sharing a power line communication medium in a time-division manner;

FIG. 18 illustrates a problem of the conventional method for sharing a power line communication medium in a time-division manner; and

FIG. 19 shows a general frame configuration in digital data communication.

### DESCRIPTION OF THE PREFERRED EMBODIMENTS

Hereinafter, embodiments of the present invention will be described with reference to the drawings.

### First Embodiment

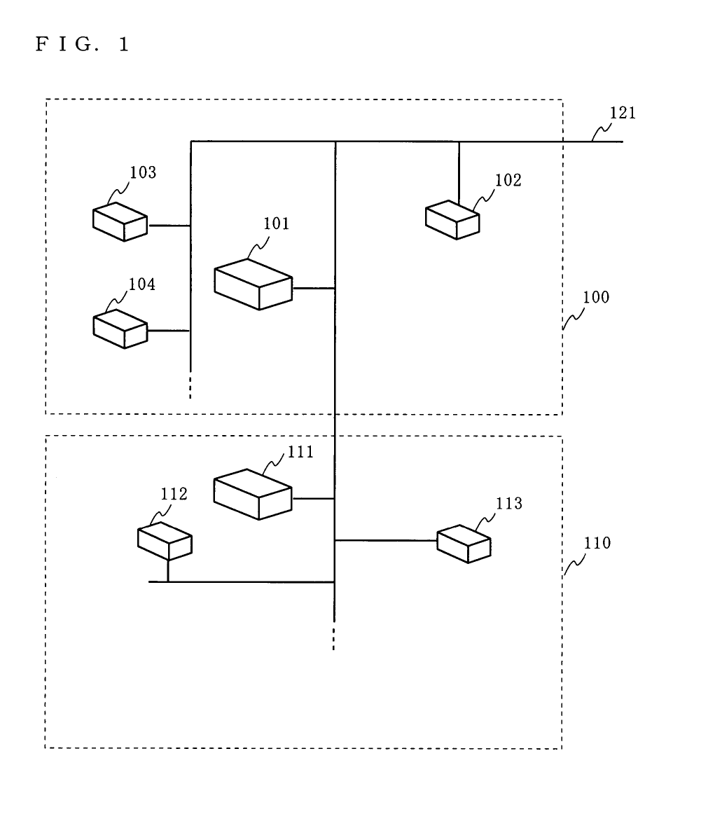

FIG. 1 shows schematic configurations of communication systems, in each of which communication apparatuses according to a first embodiment of the present invention are used. In the first embodiment, two communication systems, i.e., two power line communication systems 100 and 110 are defined. Here, the configurations of the communication systems shown in FIG. 1 are merely an example. Three or more communication systems may exist.

In FIG. 1, the power line communication systems 100 and 110 each comprise a plurality of communication apparatuses connected via a power line communication medium (hereinafter, simply referred to as a communication medium) 121. To be more specific, the power line communication system 100 comprises a master station 101 and slave stations 102, 103 and 104. The power line communication system 110 comprises a master station 111 and slave stations 112 and 113. Communication is performed in the power line communication system 100 in such a manner that the master station 101 transmits schedule information and then the slave stations 102, 103 and 104 receive the schedule information. Also, communication is performed in the power line communication system 110 in such a manner that the master station 111 transmits schedule information and then the slave stations 112 and 113 receive the schedule information.

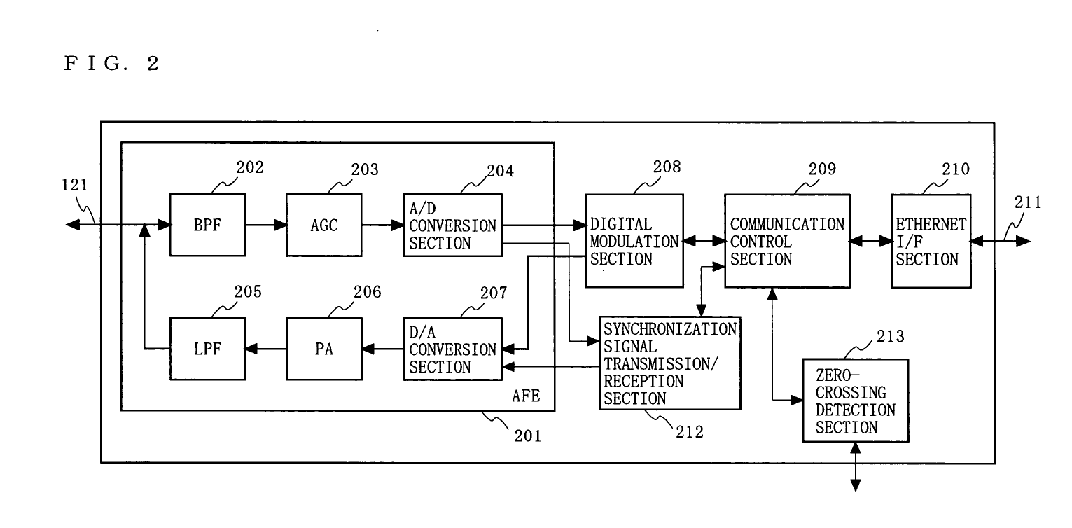

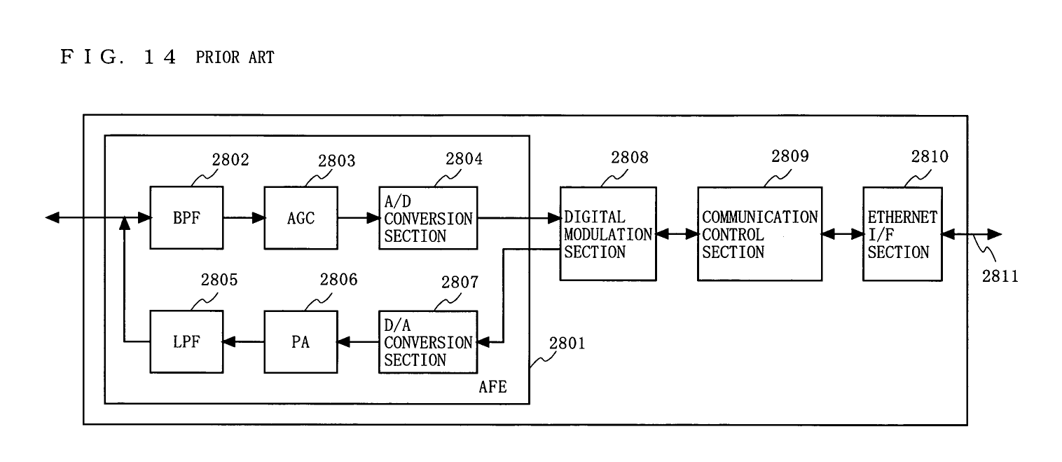

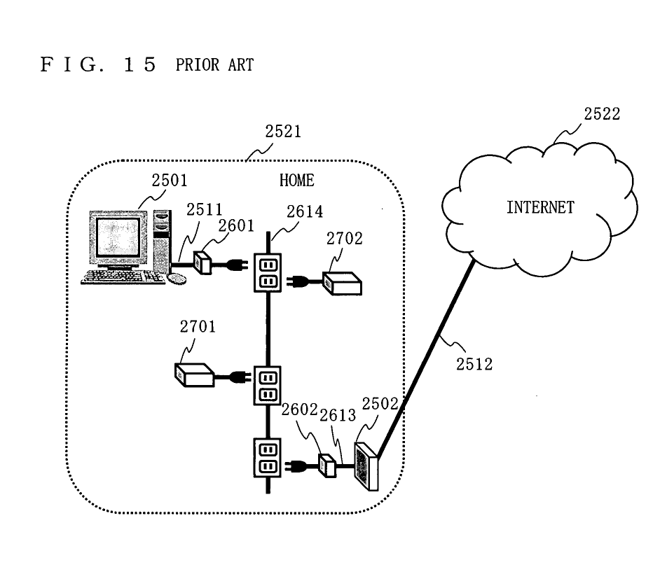

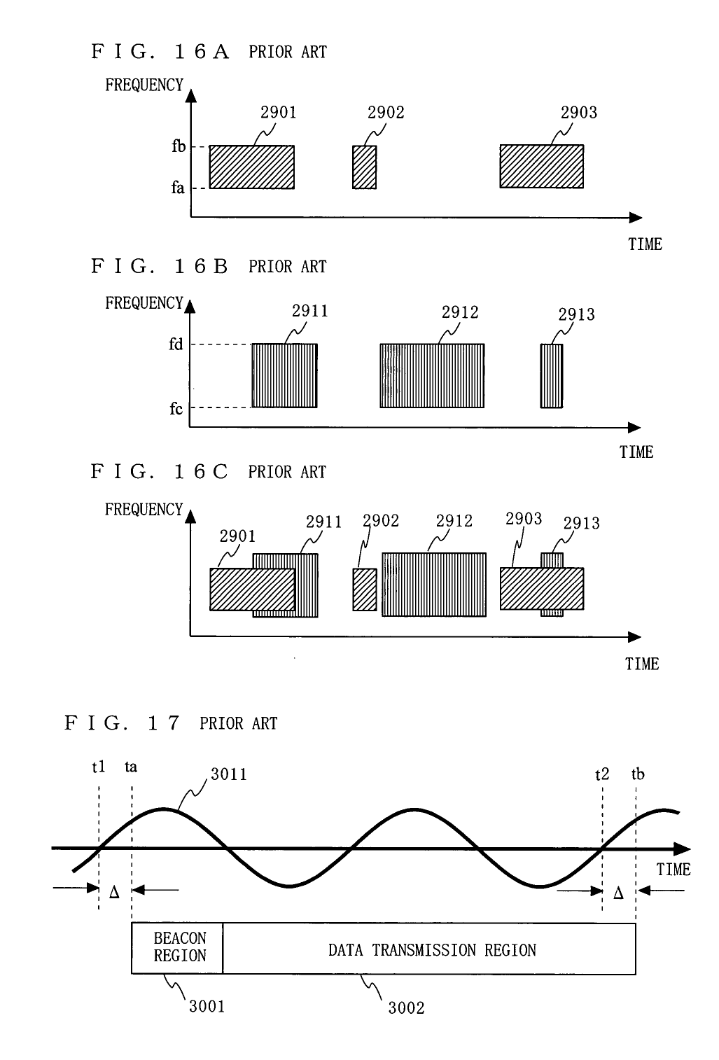

FIG. 2 is a block diagram showing an exemplary configuration of a communication apparatus according to the first embodiment of the present invention. Hereinafter, a configuration of each of the master stations 101 and 111 according to the first embodiment of the present invention will be described with reference to FIG. 2. As shown in FIG. 2, the master stations 101 and 111 each comprise an AFE (Analog Front End) 201, digital modulation section 208, communication control section 209, Ethernet® I/F section 210, synchronization signal transmission/reception section 212 and a zero-crossing detection section 213. The AFE 201 includes a BPF (Band-Pass Filter) 202, AGC (Automatic Gain Control) 203, A/D conversion section 204, LPF (Low-Pass Filter) 205, PA (Power Amplifier) 206 and a D/A conversion section 207. In other words, the configuration shown in FIG. 2 is a result of adding, to the configuration shown in FIG. 14, the synchronization signal transmission/reception section 212 and zero-crossing detection section 213. Hereinafter, operations performed by the master stations 101 and 111 will be described.

When, in the case where an Ethernet® frame is transmitted on the communication medium 121, the Ethernet® frame arrives via an Ethernet® 211, the Ethernet® I/F section 210 notifies the communication control section 209 of the arrival of the frame. The communication control section 209 outputs frame data to the digital modulation section 208. The digital modulation section 208 performs error correction addition, encoding, framing and the like to modulate the frame data into a transmission data string. The D/A conversion section 207 converts the transmission data string from a digital signal to an analog signal. The PA 206 amplifies the analog signal. The LPF 205 cuts off, from the amplified analog signal, signals other than communication band components, and inputs only the communication band components into the communication medium 121.

Next, in the case where signals are received from the communication medium 121, the BPF 202 extracts a signal of a communication band. The AGC 203 amplifies the extracted signal. The A/D conversion section 204 converts the amplified signal, which is an analog signal, into digital data. The digital modulation section 208 performs, for the digital data, frame synchronization detection, equalization, decoding, error correction and the like to demodulate the digital data, and notifies the communication control section 209 of resultant data as reception data. Thereafter, the reception data is transmitted as an Ethernet® frame from the Ethernet I/F section 210 to the Ethernet® 211.

The master stations 101 and 111 transmit to and receive from each other a synchronization signal to synchronize with each other. In the case where the master station (101 or 111) has received the synchronization signal, the synchronization signal transmission/reception section 212 generates, from a digital signal inputted from the A/D conversion section 204, a bit string representing a content of the synchronization signal, and sends the bit string to the communication control section 209. Based on the bit string representing the content of the received synchronization signal, the communication control section 209 determines, e.g., a time period during which the master station (as well as a communication system to which the master station belongs) is allowed to transmit and receive frame data, and then generates schedule information for using the determined time period, and further notifies slave stations, which belong to the communication system to which the master station belongs, of the schedule information via the D/A conversion section 207, PA 206 and LPF 205.

In the case where the master station transmits the synchronization signal, the zero-crossing detection section 213 detects a zero-crossing point of an AC power supply, and notifies the communication control section 209 of the zero-crossing point. The communication control section 209 determines a configuration of the synchronization signal to be transmitted, and also determines, based on the zero-crossing point notified from the zero-crossing detection section 213, a timing of transmitting the synchronization signal. Then, the communication control section 209 notifies the synchronization signal transmission/reception section 212 of the above configuration and timing. Based on such information notified from the communication control section 209, the synchronization signal transmission/reception section 212 generates the synchronization signal, and transmits the generated synchronization signal via the D/A conversion section 207, PA 206 and LPF 205 at the timing instructed from the communication control section 209.

Note that, the slave stations 102, 103, 104, 112 and 113 are each allowed to have either the configuration of FIG. 14 or the configuration of FIG. 2. In the configuration of FIG. 2, a functional block including the BPF 202, AGC 203 and A/D conversion section 204, and a function block including the LPF 205, PA 206 and D/A conversion section 207 are commonly used for both transmission/reception of the frame data and transmission/reception of the synchronization signal. However, instead of commonly using these functional blocks, these functional blocks may be partly or entirely added for the transmission/reception of the synchronization signal.

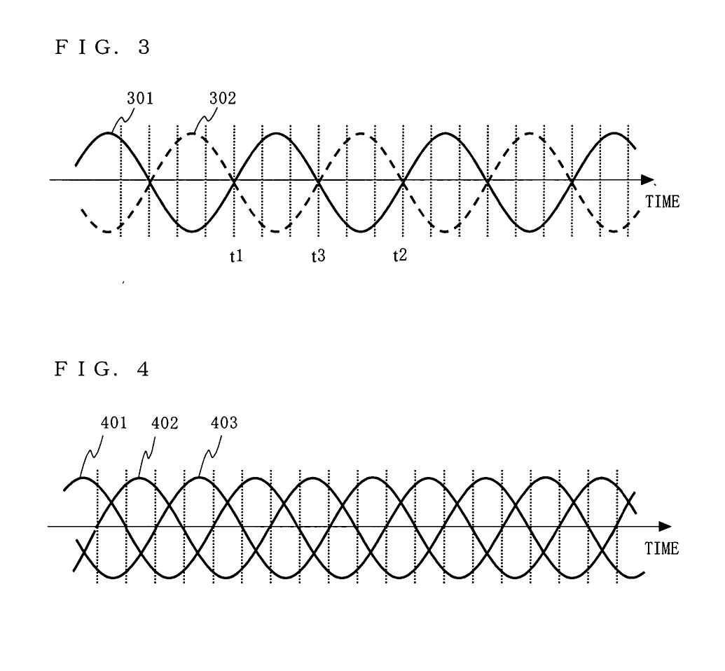

Next, a manner of determining a transmission timing of the synchronization signal is described. FIG. 3 shows single-phase voltage waveforms of AC power supply in Japan and the United States. As shown in FIG. 3, in the case of using a power line communication apparatus by inserting a plug of the apparatus to a power socket, a waveform 301 or a waveform 302 is obtained depending on an orientation in which the plug is inserted to the power socket. A phase of the waveform 301 is 0 degree at a time point t1, that is, the waveform 301 has a zero-crossing point at t1. Thereafter, the phase becomes 0 degree again at a time point t2, at which the phase has rotated 360 degrees. The waveform 302 is in opposite phase to the waveform 301. The phase of the waveform 302 becomes 0 degree at a time point t3 which is a middle point between the time points t1 and t2.

Any electrical apparatus receiving a power supply through a power socket can detect a voltage waveform, which is either one of the waveforms 301 and 302, and is allowed to synchronize with another apparatus which is a power line communication apparatus by setting, as transmission timings of a synchronization signal, points at which a phase of the voltage waveform, which said any electric apparatus has detected, becomes 0 degree and 180 degrees. Here, there is no necessity to transmit the synchronization signal at all the points at which the phase becomes 0 degree and 180 degrees. Synchronization with another apparatus which is a power line communication apparatus is also enabled by setting, while using points at which the phase becomes 0 degree and 180 degrees as origin reference points, time periods, which are each an integral multiple of a time period during which the phase changes 180 degrees, to be transmission/reception cycles of the synchronization signal.

FIG. 4 shows three-phase voltage waveforms of AC power supply in, e.g., Europe. As shown in FIG. 4, in the case of using a power line communication apparatus by inserting a plug of the apparatus to a power socket, any one of the following six voltage waveforms is obtained depending on an orientation in which the plug is inserted to the power socket: three voltage waveforms 401, 402, 403 and voltage waveforms whose phases are respectively inverted 180 degrees with respect to the phases of the waveforms 401, 402 and 403. For this reason, any electrical apparatus receiving a power supply through a power socket is enabled to synchronize with another apparatus which is a power line communication apparatus by setting, as transmission timings of a synchronization signal, time points at which a phase of a voltage waveform detected by said any electrical apparatus becomes 0 degree, 60 degrees, 120 degrees, 180 degrees, 240 degrees and 300 degrees. Similarly to the case of the single-phase AC power supply of FIG. 3, there is no necessity to transmit the synchronization signal at all the points at which the phase becomes 0 degree, 60 degrees, 120 degrees, 180 degrees, 240 degrees and 300 degrees. Synchronization with another apparatus which is a power line communication apparatus is also enabled by setting, while using any one of the above time points as an origin reference point, a time period, which is an integral multiple of a time period during which the phase changes 60 degrees, as a transmission/reception cycle of the synchronization signal.

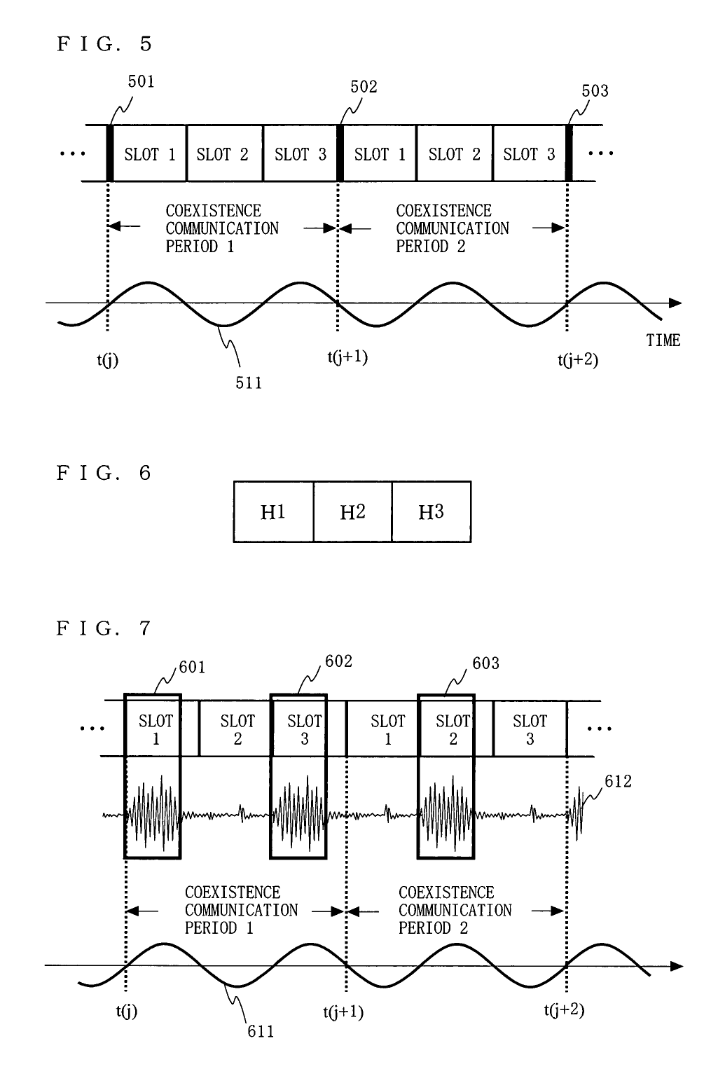

The master stations 101 and 111 synchronize with each other in the above-described manner. FIG. 5 shows the synchronization signal according to the first embodiment of the present invention and an exemplary time slots configuration for realizing TDM. In FIG. 5, a time period, which starts from a point when a phase of a waveform of the AC power supply voltage 511 is 0 degree and which has a length of 1.5 power supply cycles, is set as the coexistence communication period. Here, the phase of the waveform of the AC power supply voltage 511 becomes 0 degree at a time point t(j), and a coexistence communication period 1 starts therefrom. The coexistence communication period 1 ends at a time point t(j+1) at which a period of time having a length of 1.5 cycles of the AC power supply voltage 511 has passed from the time point t(j). Then, a next coexistence communication period 2 starts. The coexistence communication period 2 ends at a time point t(j+2) at which the period of time having the length of 1.5 cycles of the AC power supply voltage 511 has passed from the time point t(j+1). Although not shown in FIG. 5, it may be considered that a next coexistence communication period further starts from the time point t(j+2), and thereafter, the coexistence communication period, which has the length of 1.5 cycles of the AC power supply voltage 511, repeats. Similarly, it may be considered that the coexistence communication period, which has the length of 1.5 cycles of the AC power supply voltage 511, has previously repeated prior to the time point t(j).

At the head of each coexistence communication period, a time region for transmitting and receiving a synchronization signal is provided. In the coexistence communication period 1, a synchronization signal transmission/reception region 501, whose starting point is the time point t(j) which is a starting point of the coexistence communication period 1, is provided. Similarly, in the coexistence communication period 2, a synchronization signal transmission/reception region 502, whose starting point is the time point t(j+1), is provided. Similarly, each of the coexistence communication periods, which respectively exist prior and subsequent to these two coexistence communication periods, is provided with a synchronization signal transmission/reception region whose starting point is a starting point of said each of the coexistence communication periods. Generally speaking, these synchronization signal transmission/reception regions each has a same length of time. The master stations 101 and 111 realize sharing of the communication medium 121 by TDM, by transmitting to and receiving from each other the synchronization signal in these synchronization signal transmission/reception regions.

As shown in FIG. 5, three time slots are provided in each coexistence communication period so as to enable a plurality of power line communication systems to share the communication medium 121 by TDM. In the coexistence communication period 1, the synchronization signal transmission/reception region 501 is provided from the starting point t(j). Time slots 1, 2 and 3 are provided in such a manner as to trisect a time period which is from a time point immediately after the region 501 ends to a time point t(j+1) at which the coexistence communication period lends. The master stations 101 and 111 secure these time slots by using synchronization signals to be transmitted/received in the synchronization signal transmission/reception regions. In the present embodiment, three slots each having a same length are provided in the coexistence communication period. However, the number of slots is not limited to three. Also, the slots provided in the coexistence communication period are not necessarily of the same length. Moreover, divided slots may be provided along not only a temporal direction but also a frequency direction, by further dividing the coexistence communication period such that a plurality of divided periods are provided along the frequency direction.

FIG. 6 shows a configuration example of the synchronization signal according to the first embodiment of the present invention. In the example of FIG. 6, the synchronization signal comprises three temporal fields H1, H2 and H3. In the case of attempting to use the slot 1 in the coexistence communication period 1, the master stations 101 and 111 each set a predetermined signal in the field H1, and transmit the synchronization signal in the synchronization signal transmission/reception region 501. Similarly, in the case of attempting to use the slot 2 in the coexistence communication period 1, the master stations 101 and 111 each set a predetermined signal in the field H2, and transmit the synchronization signal in the synchronization signal transmission/reception region 501. Also, in the case of attempting to use the slot 3, the master stations 101 and 111 each set a predetermined signal in the field H3, and transmit the synchronization signal. This allows each of the master stations 101 and 111 to secure a time slot to be used by said each of the master stations 101 and 111 (also used by a communication system to which said each of the master stations 101 and 111 belongs to).

Although the synchronization signal is provided with three fields in the present embodiment, the number of fields is not limited to three but is changed based on the number of slots. Further, in addition to the fields H1, H2 and H3 (as well as fields which are added based on the number of slots), the synchronization signal may be provided with, for example, a field, which is used for negotiation for acquiring a right to set a signal in these fields, and a field, which is not for slot acquisition but dedicated for obtaining synchronization between systems.

FIG. 7 shows an exemplary situation where the communication systems according to the first embodiment of the present invention coexist. In FIG. 7, a noise 612 synchronizing with an AC power supply voltage 611 exists on a communication medium 721. FIG. 7 shows that the greater the waveform amplitude of the noise 612, the stronger is the noise 612. To be specific, a relatively strong noise is present during a time period starting from a point at which a phase of the AC power supply voltage 611 is 0 degree, the time period having a length of approximately 40% of a length of a power supply cycle. Note that, the synchronization signal transmission/reception regions of FIG. 5 are omitted in FIG. 7 in order to give a simplified description.

Described below is a case where the power line communication system 100 secures the slots 1 and 3, and the power line communication system 110 secures the slot 2 while such a noise as described above exists.

In the coexistence communication period 1, a region in which a strong noise is present appears twice (to be specific, a region 601 and region 602 appear). The regions 601 and 602 each overlap with a time period during which the power line communication system 100 exclusively uses the communication medium 121. In the coexistence communication period 2, a region in which a strong noise is present appears once (to be specific, a region 603 appears). The region 603 overlaps with a time period during which the power line communication system 110 exclusively uses the communication medium 121. Thus, in the coexistence communication period 1, the power line communication system 100 is required to perform communication using a transmission path in a highly deteriorated condition, whereas the power line communication system 110 is allowed to perform communication using a transmission path in a favorable condition.

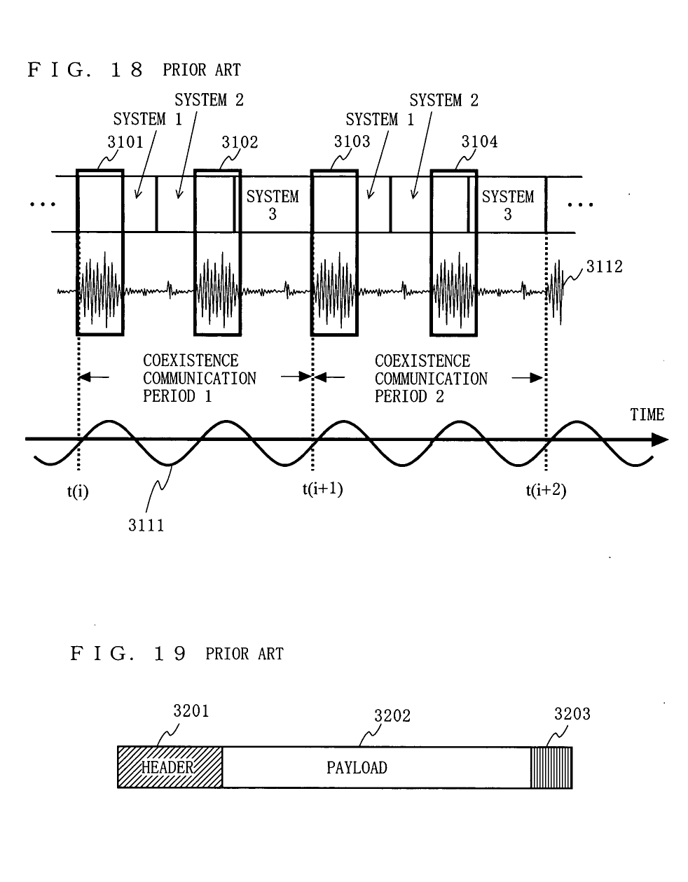

In the coexistence communication period 2, on the other hand, the power line communication system 100 is allowed to perform communication using a transmission path in a favorable condition, whereas the power line communication system 110 is required to perform communication using a transmission path in a highly deteriorated condition. This shows that setting a coexistence communication period cycle to be 1.5 times longer than the AC power supply cycle makes it possible to provide transmission path conditions, for respective systems sharing the communication medium 121, in a fairer manner than the conventional method described in FIG. 18 for sharing the power line communication medium in a time-division manner.

As described above in the first embodiment of the present invention, in the case where a noise or impedance fluctuation synchronizing with the AC power supply cycle occurs, a timing of the noise synchronizing with the AC power supply cycle can be shifted with respect to the coexistence communication period cycle, by setting the coexistence communication period cycle to be N×M+A (N: an arbitrary integer, M: the AC power supply cycle, A: an arbitrary offset value which is not an integral multiple of the AC power supply cycle). As a result, two or more power line communication systems are each equally affected by a condition of a transmission path during a time-divided communication period. Note that, there is often a case where the noise or impedance fluctuation, which synchronizes with a half cycle of the AC power supply cycle, occurs on the communication medium. In such a case, the same effect as described above is obtained by setting the coexistence communication period cycle to N×M+A (N: an arbitrary integer, M: the half cycle of the AC power supply cycle, A: an arbitrary offset value which is not an integral multiple of the half cycle of the AC power supply cycle).

### Second Embodiment

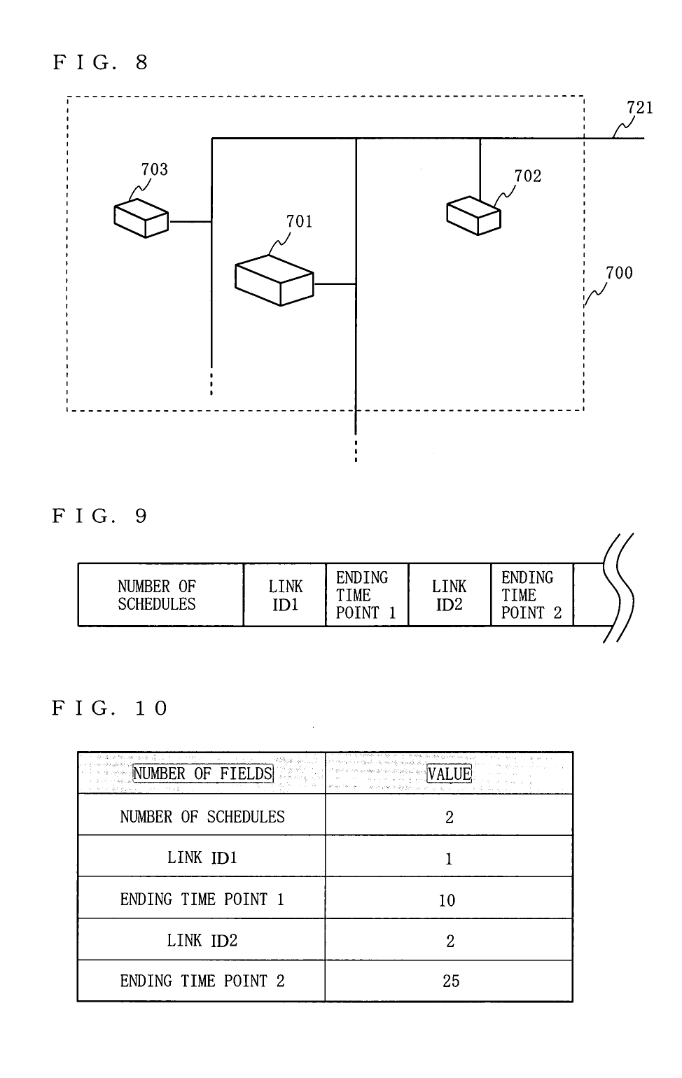

FIG. 8 shows a schematic configuration of a communication system in which communication apparatuses according to a second embodiment of the present invention are used. In FIG. 8, a single power line communication system 700 is present on a communication medium 721. A plurality of communication apparatuses belonging to the communication system 700 share a single power line 721.

In FIG. 8, the power line communication system 700 comprises a master station 701 and slave stations 702 and 703. Communication in the power line communication system 700 is performed in such a manner that the master station 701 transmits schedule information and then the slave stations 702 and 703 each receive the schedule information.

Synchronization within the power line communication system 700 is performed using a frame containing the schedule information which the master station 701 periodically transmits. Upon receiving the frame containing the schedule information, each of the slave stations 702 and 703 determines, based on a schedule written in the frame, a time period during which said each of the slave stations 702 and 703 is allowed to transmit data frame. Similarly to the first embodiment, a transmission timing of the frame containing the schedule information may be based on the zero-crossing point of the AC power supply.

FIG. 9 shows an exemplary configuration of the schedule information according to the second embodiment of the present invention. As shown in FIG. 9, the schedule information comprises a schedule number field and a plurality of pairs of a link ID field and an ending time field. The schedule number field indicates the number of link ID fields and the number of ending time fields. The link ID field is a field where an identifier for uniquely identifying a communication link, which is allowed to transmit a data frame, is written. Written in the link ID field may be, e.g., an identifier which is provided from the master station 701 in response to a request, from the slave station 702 intending to transmit a data frame, for a transmission time of the data frame.

In the ending time field, an ending time point at which a period, during which the communication link identified by the link ID field immediately prior to the ending time field is allowed to perform communication, ends is written. To be more specific, a communication link identified by a link ID field n is allowed to perform data frame transmission from a time point, which is immediately after a time point written in an ending time field (n−1), to a time point written in an ending time field n, while a time point at which the communication link has started receiving the schedule information is set to 0. Here, n is no less than 1 and no more than the number, which is determined by a value written in the schedule number field, of pairs of the link ID field and ending time field. Note that, a time point, which is a reference point for a time point set in the ending time field may be other time point than the time point at which the communication link has started receiving the schedule information, for example, a time point at which the communication link has finished receiving the schedule information.

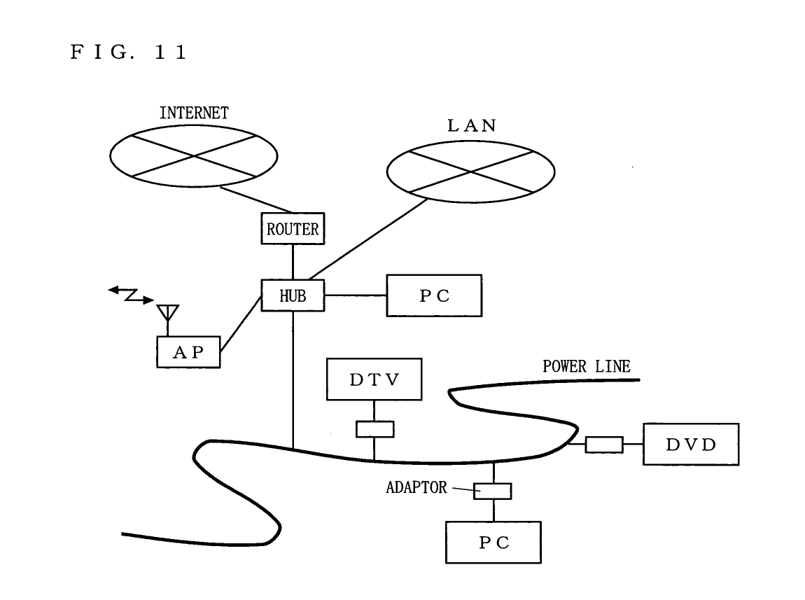

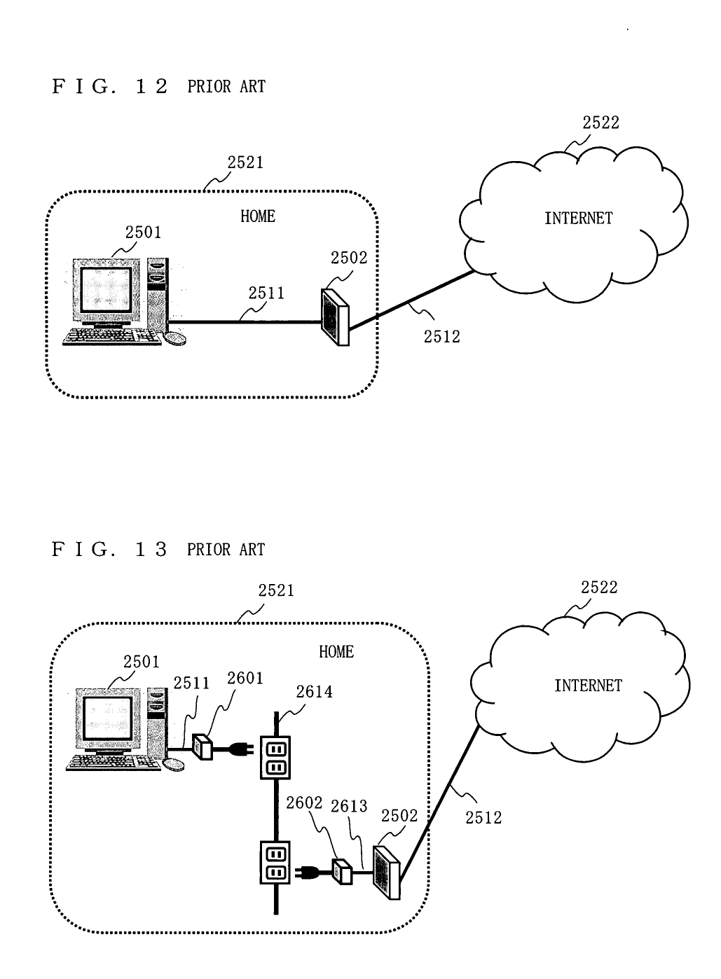

FIG. 10 shows exemplary values set in the schedule information. FIG. 10 shows exemplary schedule information in which time periods for performing communication are respectively allocated to two communication links. Here, a value of each ending time field is in a unit of msec. The schedule number field is provided with a value ‘2’, which is equal to the number of communication links to which the time periods for performing communication are allocated. A subsequent field, which is a link ID field 1, contains an ID of a communication link which is, after a reception of the schedule information is completed, first allowed to perform data frame transmission. An ending time field 1 contains an ending time of a period during which the communication link indicated by the link ID field 1 is allowed to perform data frame transmission. Here, the link ID field 1 is set to ‘1’, and the ending time field 1 is set to ‘10’. Accordingly, the communication link whose link ID is “1” is, after receiving the schedule information, allowed to perform data frame transmission until 10 msec passes from a time point at which the communication link has started receiving the schedule information.

Next, a link ID field 2 is set to ‘2’, and an ending time field 2 is set to ‘25’. Accordingly, a communication link whose link ID is “2” is allowed to perform data frame transmission from a time point, at which 10 msec has passed after the communication link has started receiving the schedule information, to a time point at which 25 msec has passed after the communication link has started receiving the schedule information. If, similarly to the first embodiment, the coexistence communication period cycle is set to be 1.5 times longer than the AC power supply cycle, the coexistence communication period cycle is 30 msec when the AC power supply voltage is 50 Hz; and the coexistence communication period cycle is 25 msec when the AC power supply voltage is 60 Hz. The schedule information shown in FIG. 10 shows all the schedules for the coexistence communication period cycle in the case where the AC power supply voltage is 60 Hz. In the case where the AC power supply voltage is 50 Hz, there exists a time interval of 5 msec between a time point, at which 25 msec has passed after the start of schedule information reception, and a time point at which 30 msec has passed after the start of schedule information reception. This time interval is not necessarily used for data frame transmission by any communication apparatus. This time interval may be used non-exclusively as a time region for CSMA (Carrier Sense Multiple Access) or the like. Alternatively, this time interval may be used for transmission/reception of a control signal within a communication system.

Since configurations of the master stations 701, 702 and 703 according to the second embodiment of the present invention are the same as those of the master and slave stations of the first embodiment, descriptions thereof will be omitted.

Similarly to the first embodiment, a frame, which contains the schedule information, and a time slots configuration, which is for realizing TDM, of the present embodiment are shown in FIG. 5. However, the present embodiment is different from the first embodiment in that a signal to be transmitted and received in each synchronization signal transmission/reception region is not the synchronization signal shown in FIG. 6 but the frame containing the schedule information shown in FIG. 9. Similarly to the first embodiment, a manner, in which the communication apparatuses in the communication system of the second embodiment of the present invention coexist, is shown in FIG. 7.

Thus, similarly to the first embodiment, when a noise or impedance fluctuation synchronizing with the AC power supply cycle occurs in the second embodiment of the present invention, a timing of the noise synchronizing with the AC power supply cycle can be shifted with respect to the coexistence communication period cycle, by setting the coexistence communication period cycle to be N×M+A (N: an arbitrary integer, M: the AC power supply cycle, A: an arbitrary offset value which is not an integral multiple of the AC power supply cycle). As a result, a plurality of communication apparatuses in a single power line communication system are each equally affected by a condition of a transmission path. Similarly to the first embodiment, in the case where the noise or impedance fluctuation synchronizing with a half cycle of the AC power supply cycle occurs, the same effect as described above is obtained by setting the coexistence communication period cycle to N×M+A (N: an arbitrary integer, M: the half cycle of the AC power supply cycle, A: an arbitrary offset value which is not an integral multiple of the half cycle of the AC power supply cycle).

In the above two embodiments, the coexistence communication period cycle ‘N×M+A’ and the offset value A are fixed. However, even if these values are used as variables, the same effect is obtained. In particular, if, in the case where the above coexistence control is performed in an area where the AC power supply cycle is 50 Hz and also in an area where the AC power supply cycle is 60 Hz in such a country as Japan, the coexistence communication period is fixed based on the AC power supply cycle, a length of the coexistence communication period differs between the 50 Hz area and 60 Hz area. Since power line communication is performed on an unstable transmission path, a header region of a data transmission frame is large (80 μsec, for example). For this reason, the difference in the length of the coexistence communication period causes a transmission efficiency to vary. In order to prevent such a problem, the communication apparatus of the present invention changes, based on the AC power supply cycle, a ratio between the coexistence communication period cycle and power supply cycle, thereby preventing communication efficiencies in the respective areas from varying. The same effect as above can also be obtained by using a zero-crossing point of a two-phase power supply.

To be specific, the zero-crossing detection section 213 may further have a function for automatically detecting the AC power supply cycle and then notifying the communication control section 209 of the AC power supply cycle. For example, the zero-crossing detection section 213 automatically detects whether the AC power supply cycle is 50 Hz or 60 Hz, and then notifies the communication control section 209 of a detection result. Accordingly, the communication control section 209 optimally determines, based on a value of the AC power supply cycle, the coexistence communication period cycle.

Function blocks illustrated in the above-described embodiments such as the synchronization signal transmission/reception section 212 and the communication control section 209 are typically realized as LSIs which are integrated circuits. These function blocks each may be realized as an individual chip, or a chip which partly or entirely includes these function blocks may be provided. Alternatively, components, which are involved in communication performed within a system to which the components belong, may be provided as an individual LSI chip, and also components, which are involved in coexistence signal transmission/reception, may be provided as an individual LSI chip. Although these chips are referred to here as LSIs, these chips may be IC chips, system LSI chips, super LSI chips or ultra LSI chips, depending on an integration density thereof.

When the function blocks are realized as integrated circuits, the integrated circuits are not necessarily limited to LSIs. The integrated circuits each may be realized as a dedicated circuit or a general-purpose processor. Further, a Field Programmable Gate Array (FPGA), which can be programmed after LSI production, or a reconfigurable processor, which enables connections or settings of circuit cells in LSI to be reconfigured, may be used.

Further, if a new circuit integration technology to be replaced with an LSI technology is developed as a result of an advance in semiconductor technology, or is developed based on a technology derived from semiconductor technology, the function blocks may, of course, be integrated using such a technology. There may be a possibility of application of biotechnology or the like.

Each of the above-described embodiments may be realized in such a manner that a CPU interprets and executes predetermined program data contained in a storage medium (ROM, RAM, hard disk or the like), which predetermined program data allows the above-described process steps to be performed. In such a case, the program data may be supplied into a storage device via the storage medium, or the program data may be directly executed on the storage medium. Here, the storage medium may be, for example: a semiconductor memory such as a ROM, RAM, flash memory or the like; a magnetic disk memory such as a flexible disc, hard disk or the like; an optical disc such as a CD-ROM, DVD, BD or the like; and a memory card. Referred to here as a storage medium may also be a communication medium such as a telephone line or transmission path.

The communication apparatus of the present invention may be in the form of an adaptor which converts a signal interface, such as an Ethernet® interface, IEEE1394 interface, USB interface or the like, into an interface for power line communication. This enables the communication apparatus to be connected to multimedia apparatuses, such as a personal computer, DVD recorder, digital television, home server system and the like, which have various types of interfaces. This allows a network system, which is able to transmit, with a high speed, digital data such as multimedia data or the like by using a power line as a medium, to be constructed. As a result, unlike a conventional wired LAN, there is no necessity to newly place a network cable, and a power line already provided in homes, offices and the like can be used as a network line. Therefore, the present invention is considerably useful in terms of cost and ease of installation.

If, in the future, functions of the present invention are incorporated into multimedia apparatuses such as a personal computer, DVD recorder, digital television, home server system and the like, data transfer to be performed between the multimedia apparatuses via power codes thereof will be enabled. In this case, an adaptor, Ethernet® cable, IEEE1394 cable, USB cable and the like are no longer necessary, and thus wiring is simplified.

The communication apparatus of the present invention can be connected via a rooter to the Internet. Also, the communication apparatus can be connected via a hub or the like to a wireless LAN or a conventional wired LAN. Therefore, there is no difficulty in extending a LAN system in which the communication system of the present invention is used.

Described below is an example where the present invention as described in the above embodiments is applied to an actual network system. FIG. 11 shows an exemplary network system in which the present invention is applied to power line transmission. In FIG. 11, an IEEE1394 interface, USB interface and the like of multimedia apparatuses, such as a personal computer, DVD recorder, digital television, home server system and the like are connected to a power line via adaptors having functions of the present invention. This allows a network system, which is able to transmit, with a high speed, digital data such as multimedia data or the like by using the power line as a medium, to be constructed. In this system, unlike a conventional wired LAN, there is no necessity to newly place a network cable, and a power line already provided in homes, offices and the like can be used as a network line. Therefore, the present invention is considerably useful in terms of cost and ease of installation.

In the above example, existing multimedia apparatuses are applied to power line communication by using the adaptors which convert signal interfaces of the existing multimedia apparatuses into an interface for power line communication. In the future, however, the functions of the present invention will be incorporated into multimedia apparatuses, whereby data transfer to be performed between the multimedia apparatuses via power codes thereof will be enabled. In this case, adaptors, IEEE1394 cable, USB cable and the like shown in FIG. 11 are no longer necessary, and thus wiring is simplified. The communication apparatus of the present invention can be connected via a rooter to the Internet, and also connected via a hub or the like to a wireless or wired LAN. Therefore, the extension of a LAN system, in which the power line transmission system of the present invention is used, is possible. In a power line transmission scheme, communication data is transferred via a power line. For this reason, unlike a wireless LAN, a power line transmission scheme does not have a problem in that a radio wave is intercepted whereby data leakage is caused. Therefore, a power line transmission scheme is effective for data protection in terms of security. Of course, data transferred on a power line is protected by, for example, an IP protocol IPSec, content encryption, or other DRM schemes.

Thus, high-quality AV content transmission using a power line is achieved by having functions including: a copyright protection function using content encryption; and a function for enabling a communication medium to be commonly used in a fair manner, which is an effect of the present invention.

The communication apparatus of the present invention is useful for, e.g., realizing data communication which is performed in a fair manner among a plurality of communication systems.

While the invention has been described in detail, the foregoing description is in all aspects illustrative and not restrictive. It is understood that numerous other modifications and variations can be devised without departing from the scope of the invention.

What is claimed is:

1. A communication apparatus belonging to one of two or more communication systems which are capable of sharing a single communication medium in a time-division manner, the communication apparatus comprising:
a communication control section for, when the two or more communication systems share the single communication medium in a time-division manner, determining a coexistence communication period, which is cyclically allocated to the communication systems, to be N×M+A (N: an arbitrary integer, M: a half cycle of an AC power supply cycle, A: an arbitrary offset value which is not an integral multiple of the half cycle of the AC power supply cycle); and
a synchronization signal transmission/reception section for transmitting and receiving a synchronization signal to and from a communication apparatus, which belongs to another one of the two or more communication systems, so as to synchronize with the communication apparatus.

2. The communication apparatus according to claim 1, wherein the offset value A is L/M (L is an arbitrary real number satisfying 0<L<M).

3. The communication apparatus according to claim 1, wherein the synchronization signal transmission/reception section transmits and receives the synchronization signal by setting, as a synchronization signal transmission/reception region, a predetermined time period from a starting point of the coexistence communication period determined by the communication control section.

4. The communication apparatus according to claim 1, further comprising a zero-crossing detection section for detecting a zero-crossing point of an AC power supply, wherein
the communication control section instructs, based on the zero-crossing point detected by the zero-crossing detection section, the synchronization signal transmission/reception section about a timing of transmitting the synchronization signal.

5. The communication apparatus according to claim 4, wherein
the zero-crossing detection section automatically detects the AC power supply cycle, and
based on the AC power supply cycle detected by the zero-crossing detection section, the communication control section determines the coexistence communication period.

6. A method performed by a communication apparatus belonging to one of two or more communication systems which are capable of sharing a single communication medium in a time-division manner, the method comprising:
a communication control step of, when the two or more communication systems share the single communication medium in a time-division manner, determining a coexistence communication period, which is cyclically allocated to the communication systems, to be N×M+A (N: an arbitrary integer, M: a half cycle of an AC power supply cycle, A: an arbitrary offset value which is not an integral multiple of the half cycle of the AC power supply cycle); and
a synchronization signal transmission/reception step of transmitting and receiving a synchronization signal to and from a communication apparatus, which belongs to another one of the two or more communication systems, so as to synchronize with the communication apparatus.

7. An integrated circuit used for a communication apparatus belonging to one of two or more communication systems which are capable of sharing a single communication medium in a time-division manner, the integrated circuit comprising:
a communication control section for, when the two or more communication systems share the single communication medium in a time-division manner, determining a coexistence communication period, which is cyclically allocated to the communication systems, to be N×M+A (N: an arbitrary integer, M: a half cycle of an AC power supply cycle, A: an arbitrary offset value which is not an integral multiple of the half cycle of the AC power supply cycle); and
a synchronization signal transmission/reception section for transmitting and receiving a synchronization signal to and from a communication apparatus, which belongs to another one of the two or more communication systems, so as to synchronize with the communication apparatus.
